(19) United States
(12) Patent Application Publication
(10) Pub. No.: US 2010/0202510 A1
(43) Pub. Date: Aug. 12, 2010

(54) COMPACT REAL-TIME VIDEO TRANSMISSION MODULE

(76) Inventor: Albert S. Kyle, Andover, MA (US)

Correspondence Address: CESARI AND MCKENNA, LLP, 88 BLACK FALCON AVENUE, BOSTON, MA, 02210, US

(21) Appl. No.: 12/702,994

(22) Filed: Feb. 9, 2010

Related U.S. Application Data
(60) Provisional application No. 61/151,055, filed on Feb. 9, 2009.
(60) Provisional application No. 61/153,176, filed on Feb. 17, 2009.

(51) Int. Cl. H04N 5/38; H04N 7/26

(52) U.S. Cl. 375/240.01; 348/723; 348/E05.093

(57) ABSTRACT

The invention comprises a low cost, lightweight, self-contained video transmission module for transmitting streaming video images from a video image source to a remote location over a packet-switched network such as the internet. The transmission module requires no user skill or expertise to connect or to operate and provides high quality real-time streaming video to remote users. The transmission module is especially useful for transmitting images from medical equipment such as XRay, CT, MRI and ultrasound equipment at a medical site which does not otherwise have access to video conference capabilities to thereby enable consultation with specialists at a remote location. Thus, it is expected to be especially beneficial to smaller and poorer medical sites, as well as enabling real-time consultation from mobile vehicles such as ambulances or helicopters. It also is expected to be useful in other applications involving remote consultations accompanied by video streaming.

### CROSS-REFERENCE TO RELATED APPLICATIONS

The present application claims the benefit of U.S. Provisional Patent Application Ser. No. 61/151,055, which was filed on Feb. 9, 2009, by Albert S. Kyle for a METHOD AND DEVICE FOR IMAGE TRANSMISSION AND REVIEW and U.S. Provisional Patent Application Ser. No. 61/153,176, which was filed on Feb. 17, 2009, by Albert S. Kyle for a METHOD AND DEVICE FOR OPERATOR TRAINING FOR IMAGING SYSTEMS and is hereby incorporated by reference.

### BACKGROUND OF THE INVENTION

Today's health care environment is highly distributed, requiring that complex imaging procedures and technical support may be performed at locations that are distant from primary hospital and private practice laboratories and technical support centers. Maintaining quality control in imaging and service support is therefore difficult, because experienced staff may not be available at remote sites where the imaging equipment resides. This complicates the quality of imaging services, and the economical and efficient delivery of technical support services for caregivers, manufacturers and independent service organizations that want to deliver quality service at a low cost.

The medical imaging modalities, including XRAY, CT, MRI, OCT, visible light and ultrasound, have much in common, and also many differences. Compared with other imaging modalities, the benefits of ultrasound include portability/mobility, which allows ultrasound imaging to be done at the patient's bedside, in critical care units, emergency departments (ER) and remote locations including clinics and private medical practices. Many medical specialists are qualified to perform ultrasound imaging, including radiologists, cardiologists, OB-GYN, emergency medicine specialists and non-physician ultrasound technologists.

Medical imaging systems—in particular ultrasound imaging system—can be difficult to operate under ideal conditions, and even more difficult to operate when a complex procedure is being performed. An example of complex procedures is adult and pediatric congenital echocardiography ultrasound studies. Commonly, the person performing the imaging and the person who will interpret the image are different, and may be in different locations. If a specialist views an image while it is being acquired, or in nearly the same time as the operator who is acquiring the image, the communication between operator and specialist regarding techniques of acquisition will be enhanced and the quality of image acquisition can be improved. In turn, better quality images result in more accurate interpretations, leading to improved patient care and better patient outcomes. This is particularly true for complex procedures or even relatively simple procedures that are done infrequently. There is a need for interaction between imaging system operators and imaging specialists. When operator and specialist are in different locations, this need could be met by improvement in real-time image transmission to enable communication during an imaging procedure.

In the healthcare environment, image transmission, retrieval and storage are addressed by the ACR NEMA DICOM standard. The DICOM standard has been adopted by many health care providers, in order to ensure that images acquired on an imaging system manufactured by one company (for example GE, Siemens or Philips) can be displayed on terminals from another manufacturer. Similar to imaging systems, picture archiving systems (PACS) are also compatible with the DICOM standard for the same reason. Indeed, some medical imaging system customers will only purchase imaging systems that are compliant with the DICOM standard. And, many manufacturers will only supply products that are DICOM compliant, in order to avoid potential problems with customers who purchase exclusively DICOM compliant imaging systems.

In the past, DICOM has not supported video streaming and real-time image review over networks for most imaging system modalities. Consequently, in spite of the wide availability of video streaming on computers and laptops, it has not been provided by medical imaging manufacturers. Many manufacturers of medical imaging systems—including CT, MRI and ultrasound—do not offer video streaming capability on their imaging systems. Real-time viewing of medical images has therefore not been available as a standard or optional feature on most medical imaging systems. Recently, the video is compression and streaming method MPEG2was approved as a DICOM transfer syntax, and MPEG 4 is expected to be approved within a year of this writing. However, many imaging system manufacturers have been slow to implement the MPEG2 compression method. Consequently, video streaming lacks wide availability within the medical imaging industry.

Most low and medium priced ultrasound systems are not web-enabled for video streaming, lack a DICOM interface for image file transfer using the store and forward approach, and lack access to remote diagnostics for remote technical support. In short, most low and medium priced ultrasound systems have little or no connectivity. When compared with CT and MRI, the quality of ultrasound images is known to be “operator and patient dependent.” That is, cockpit problems and the biological and anatomical variability of patients imaged with ultrasound can cause wide variability in images. Thus in spite of the need for remote support of ultrasound systems, it is unavailable. In the US alone, it is estimated that more than 140,000 ultrasound imagers are installed, the majority of which are low and medium priced systems. Thus, 100,000 or perhaps more ultrasound imagers lack connectivity and remote support capability. For many ultrasound users real-time streaming and remote viewing is an unmet need.

This contrasts with large medical imaging systems such as, CT and MRI that often include remote diagnostic software and solutions for troubleshooting over networks. Thus, for large and relatively expensive medical imaging systems, image specialists located in the manufacturer's sites—sometimes referred to as response centers—can review images required remotely at a customer site, diagnose and sometimes even repair the system by downloading software, all done remotely. These imaging systems are connected to the manufacturer by high speed computer and telecommunications networks and channels via the Internet. However, these large medical imaging systems remote diagnostics systems and methods normally do not support real-time methods such as video conferencing and video streaming of images.

For those systems where remote technical support is available, images are often transmitted in DICOM format with the store and forward method, but are not available for viewing by support staff in real-time. And sometimes, remote diagnostics, although they are available, are sometimes rendered ineffective, because of changes in local area networks configurations at the customer site. Changes in the imaging systems, or IT networks—including changes in the firewall configuration settings—can disable the remote diagnostic capability of the image system manufacturers. Remote diagnostics using store-and-forward of image files for CT and MRI systems via the Internet are therefore not 100% effective. For many CT and MRI users, real-time streaming and remote viewing could be a benefit for technical support, but is an unmet need.

In summary, medical imaging systems are typically located in hospitals and clinics, but specialists who need to review the images or delivery technical support for the system may be at sites that are located at a distance from the operator. For imaging system providers, these sites could be corporate response centers, independent service organizations that provide technical support for a plurality of imaging systems. For healthcare providers, these sites could be specialized laboratories or third party companies who provide image reading services performed by medical practitioners (“night hawk” companies). In all cases, it may be beneficial for the operator at the remote site where the imaging system is located, and another person located at a centralized site to view the same image in essentially the same time. That is, “real-time” viewing of can be important for a variety of reasons. In this context, the term “real-time” does mean that a viewer of the image who is located at a distance can view the image in approximately the same time as the operator who is located with the imaging system. For many imaging system users, real-time image streaming over networks is an unmet need.

### SUMMARY OF THE INVENTION

Many industrial and medical imaging systems including XRAY, CT, MRI and ultrasound provide video formatted outputs, including S-video, composite video and high definition video (HDMI). The present invention takes advantage of this by providing a single universal interface device that accepts one or more of these video inputs and adapts them for transmission to a remote viewing station over networks, including wired or wireless private networks and the Internet. The invention is compact, easy to install, easy to use, and low cost. The use of video formatted outputs as a interface avoids the cost of special customized digital interfaces that are costly, and that can change when software revisions change. In contrast, video formats are relatively more stable and universal, allowing a single method and device to provide interface to networks for a plurality of imaging systems.

Its applications include (1) remote consults between an imaging specialist at a host site and an imaging operator at a remote site to answer questions, perform training is and re-training for imaging system operation (2) remote consults between a specialist at a host site and an imaging service person or engineer at a remote site to enable technical support of imaging systems, including diagnosis and repair (3) real-time quality assurance (RTQA) by a medical imaging specialist for an imaging operator, or assistance for pre hospital personnel during patient transport in order to guide therapy, mobilize resources or redirect the ambulance.

The invention enables distance-learning training and real-time consult for imaging procedures for a variety of imaging applications in a variety of clinical and business settings.

In one embodiment, the imaging applications are commercial in nature, where the system operator is a service technician or applications specialist employed by an imaging manufacturer or third-party company that represents imaging system manufacturers or provides technical services for imaging systems, and the imaging specialist is a technical expert located at a response center. In another embodiment, the system operator is a sonographer or medical doctor who is gaining or augmenting understanding of a new medical procedure, performing imaging for therapy guidance, and the imaging specialist is an experienced medical professional. In another embodiment, the operator is a sonographer or medical doctor seeking a consult on a complex imaging procedure, including ultrasound imaging for endocrinology, emergency medicine, musculoskeletal, regional anesthesia, adult and pediatric echocardiography procedures, and the imaging specialist is an experienced medical professional. In another embodiment, the system operator is a pre-hospital medical professional seeking a consult to identify a patient's condition during transport, and the imaging specialist is a trained professional that is expert in emergency medicine. Because of its small size and light weight, the system is particularly suited to emergency diagnoses while a patient is being transmitted to a medical facility. For all embodiments, the invention provides a distance learning consult service for an imaging system operator located at the point of service by a specialist at a remote host site.

### BRIEF DESCRIPTION OF THE DRAWINGS

The invention description below refers to the accompanying drawings, of which:

FIG. 1 is a schematic block diagram of the compact interface module of the present invention.

### DETAILED DESCRIPTION OF AN ILLUSTRATIVE EMBODIMENT

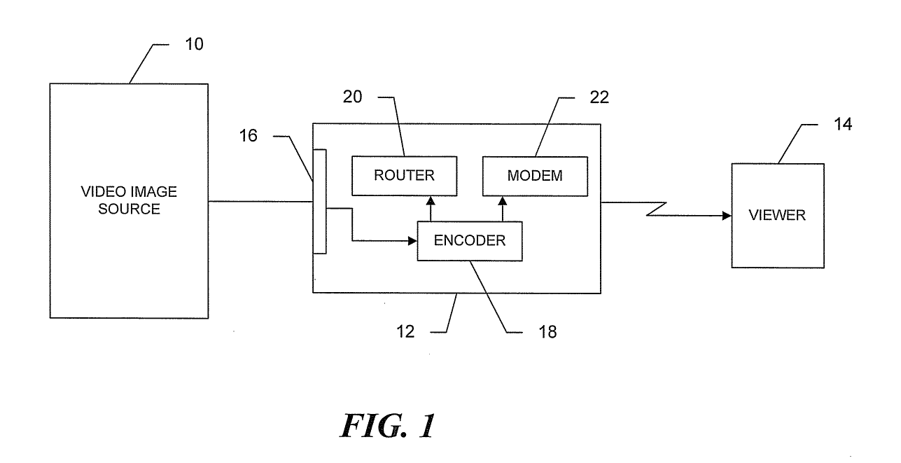

In FIG. 1, a source of video signals 10 supplies these signals to a compact transmission module 12 which transmits these signals over a network using an internet protocol e.g., the Internet Protocol) such as a wired or wireless private network or the internet to a remote viewing station 14. The video signals may comprise any of the common video signals such as composite video, S-video, HDMI, DVI, or VGA, etc. As new types of video signals become available, these can also be provided for.

The video signals are supplied to the transmission module 12 through a connecter 16 which has a connector strip that provides an input connector to match the output connector of the particular video source 10. The output of the connector strip is applied to an encoder 18 which encodes the video for transmission in substantially real time over the network. By “substantially real time”, I mean with time lags typically not larger than minutes and most commonly of the order of seconds. The specific lag will depend, of course, primarily on the bandwidth of the network being utilized.

In one embodiment of my invention, I use a MPEG-4 AVC/H.264 encoder. This offers very high coding efficiency and picture quality at moderate computational complexity in order to accommodate networks with lower bandwidth.

The output of the encoder is applied to a wireless bridge or router 20 and/or a wireless modem 22. The router transmits the encoded images over at least a first wireline or wireless link; thereafter they may be carried to their destination over one or more further wireline, wireless, or other form of links as is common in the internet. Conversely, the wireless modem transmits the encoded images over at least a first wireless link; thereafter they may be similarly carried to their destination over one or more further wireless, wireline, or other links.

The interface module 12 is advantageously contained in a separate enclosure with its own power supply, capable of 110/220 volt or external battery powered operation. This allows equipments such as a portable, battery-powered ultrasound imager to operate while connected with a portable, external battery-powered interface module, enabling the operator to image the patient while still being connected to the reviewer inside or outside a vehicle, such as an ambulance or helicopter.

The viewer 14 advantageously runs on an ordinary personal computer such as those that are commonly available from a variety manufacturers including, inter alia, Apple, Hewlett Packard, Dell, Sony, etc. The only specialization required is the viewing software itself. In one embodiment, I have used the VLC media player which is available for download from the Video LAN Team, http://www.videolan.org. Other viewing software programs are also commonly available and may be used.

The viewing software has two primary modes: set-up and real-time viewing. To initiate set-up mode, in one embodiment, the imaging specialist (viewer) starts the imaging software, chooses the system from which data is to be received, and then selects the image transmission parameters that are appropriate for the study. The imaging system operator (remote user) need not control the system: this is done by the imaging specialist to whom the video is being sent. The parameter choices are found in a drop-down menu that is activated by clicking on the “options” tab. The optimal parameter choices may depend on the ambient light conditions, the strength of the bandwidth that are available on wired or wireless networks, and the combination of image resolution and frame rate that are desired by the viewer. For wireless networks, depending on location, weather conditions and time of day, signal strength can vary from (approximately) 50-1000 kbps, with a typical value of 140-700 kbps in populated areas. For abdominal imaging s performed with normal conditions of 3G signal strength, parameter values typically are 320×240video resolution, and 6 video frames per second. For echocardiography studies, 320×240video resolution and 20-30 video frames per second are common. Ideal conditions and stronger signals will allow higher bandwidths that enable selection of higher resolution and frame rates.

Prior to an imaging session, the operator at the remote site ensures that the interface module is powered up and connected to the ultrasound imaging system. There are no operator controls on the interface module. The imaging specialist at the host site initiates the imaging session by opening the viewing software to automatically connect with the interface module and imaging system.

To initiate real-time viewing mode, the viewer either enters an address in the browser, or clicks an icon on the workstation screen. This initiates the link between the interface module and imaging specialist's workstation. Initiating the link “calls up” the image from the remote site and the image is automatically displayed in the workstation viewing window. When the session is complete, the imaging specialist clicks the icon or logs off the browser, and the link between remote site and viewing site is closed.

The consult session is conducted via video teleconference between the imaging system operator at the point-of-service site, and an imaging specialist at a remote host site. The video image is transmitted over a network in real-time or in approximately real-time with a reasonable latency delay. A reasonable latency delay depends on the network quality and could be a few seconds, or even longer. The audio channel can be the plain old telephone system, or can be electronically integrated and combined with the video channel by the interface module and runs as voice-over-internet-protocol, or VOIP. The duration of the consult session can range from a few minutes to one-hour, more or less. The consult may be performed during a scheduled diagnostic imaging session or image-guided intervention when a patient is present, off-line in a scheduled consult training session in an emergency situation or after hours for a technical support session to accomplish system repair, troubleshooting or software downloads.

At the point-of-service site, the operator connects the video output from an imaging system to the transmission module. The specialist views the real-time images in video streamed format. The specialist has control of certain imaging parameters including contrast and brightness, in order to optimize image quality according to the network performance and local light conditions. There are no imaging controls on the I/F module at the point-of-service site. The images are streamed automatically, allowing the imaging system operator to concentrate on making the best images possible. Thus, imaging system operation is not affected by the video teleconference consult session.

In some instances, the user of the system may not have preexisting access to a packet-switched network. To accommodate such case, it may be desirable to incorporate into the interface module a subscription to an internet service, preferably both wired and wireless. To enable broadband wireless image transmission, in one embodiment a USB compatible 3G modem device can first be purchased with a 3G Internet service subscription, and second be introduced into the modem 22 within the interface module enclosure 12. In another embodiment, a combination 3G hotspot+Wifi router such as the Mifi device can be purchased as part of a 3G Internet service subscription, and operate external to the interface module enclosure 12.

In another embodiment, the interface module consists of software loaded on printed circuit card, which can operate within the architecture of a portable, battery-powered ultrasound system, thereby avoiding the need for a separate enclosure.

As may be seen from the foregoing, the interface module 12 of the present invention opens a new world for remote video applications, particularly in the medical imaging field. The system is relatively inexpensive to build (typically, less than one thousand dollars); is entirely self-contained so that users need only connect the video input cable in order to use it; is lightweight (typically, 1 kg); and is compact (one embodiment, for example, measured 26 cm×18 cm×11 cm). Medical sites which may lack financial and human resources or the sophisticated transmission facilities normally required for real-time image transmission in the medical field can now have access to is experienced specialists who can view high frame rate and high resolution images over existing networks.

What is claimed is:

1. A video transmission module for streaming video images over a packet-switched network comprising:
an enclosure;
a connector terminal within said enclosure for receiving video signals from an external source;
an encoder within said enclosure for compressing said video signals; and
a transmission element within said enclosure for receiving compressed video from said encoder and transforming said video into a format adapted to transmission over a packet-switched network.

2. A video transmission module according to claim 1 in which said transmission element comprises at least one of a bridge or router and a wireless modem.

3. A video transmission module according to claim in which said transmission element includes both a router and a wireless modem.

4. A video transmission module according to claim 1 in which said video signals comprise video in one or more formats, including compact video, S-video, HDMI, DVI and VGA, among others.

5. A video transmission module according to claim 1 in which said encoder encodes the video signals into a format including an Mpeg format, among others.

6. A video transmission module according to claim 1 which further includes a power supply for providing power to said encoder and said transmission element.

7. A video transmission module according to claim 1 in which said network includes one includes one or more of Ethernet, WiFi, and mobile broadband cellular networks.

8. A video transmission module according to claim 1 which includes a subscription to a packet-switched network.
